(19) United States
(12) Patent Application Publication
(10) Pub. No.: US 2007/0092783 A1
(43) Pub. Date: Apr. 26, 2007

(54) Methods of synchronizing process flows within hierarchical process flows and systems for use with the methods

(75) Inventor: John K. Gibbons, Center Point, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: PlanView, Inc., Austin, TX (US)

(21) Appl. No.: 11/586,432

(22) Filed: Oct. 24, 2006

Related U.S. Application Data
(60) Provisional application No. 60/729,507, filed on Oct. 24, 2005.

(51) Int. Cl. H01M 4/00

(52) U.S. Cl. 429/40

(57) ABSTRACT

A method of generating a hierarchical process flow can include generating a first command within a first process flow of the hierarchical process flow, wherein the first command includes a wait condition that has a first trigger status value for a first object associated with a second process flow of the hierarchical process flow, and the second process flow is a child of the first process flow. The method can also include generating a second command within the second process flow, wherein when executed, the second command sets a corresponding status value of the first object to the first trigger status value. Processing readable media, systems, or any combination thereof can be used in performing the methods described herein.

### RELATED APPLICATION

This application claims the benefit of priority under 35 U.S.C. §119(e) from provisional U.S. Application No. 60/729,507, filed Oct. 24, 2005, which is incorporated herein by reference in its entirety.

### FIELD OF THE DISCLOSURE

The disclosure relates in general to methods and systems, and more particularly, to methods of synchronizing process flows within hierarchical process flows and systems for use with the methods.

### DESCRIPTION OF THE RELATED ART

Process flows can be used in performing routine operations within a company. An example can include a process flow for handling an order for a product after the order is received from a customer until the product is shipped to the customer, the customer is invoiced, or any combination thereof. Because the process flow will be used repeatedly, large amounts of resources used to develop code customized for the process flow is justified.

Many other process flows can be more complicated, involve a hierarchy, not be routine, or any combination thereof. Such process flows may be customized each time they are used, and therefore, extensive code development is not usually justified. In additional, such process flows may be designed by a business person to perform the process flow correctly when executed by a data processing system or another automated system. The ability to coordinate between different process flows within a hierarchical process flow may be needed or desired. However, the business person may not have the ability, the time, the appropriate resources (e.g., code developers, code testers, etc.), or any combination thereof to generate code to coordinate properly between the process flows.

### BRIEF DESCRIPTION OF THE DRAWINGS

FIG. 1 includes an illustration of a portion of an exemplary hierarchical process flow.

FIG. 2 includes a flowchart for generating a hierarchical process flow that includes synchronization between different process flows within the hierarchical process flow.

FIGS. 3 and 4 include flowcharts for generating and executing using, respectively, the hierarchical flow chart, when a parent process flow waits for a child process flow.

FIGS. 5 and 6 include flowcharts for generating and executing using, respectively, the hierarchical flow chart, when a child process flow waits for a parent process flow.

FIG. 7 includes a diagram of an illustrative embodiment of a general data processing system.

FIG. 8 includes a portion of a project workflow to illustrate how synchronization between process flows within the project workflow can be used in a non-limiting example.

### DETAILED DESCRIPTION

A hierarchical process flow can include a plurality of process flows at different levels, wherein different process flows can be synchronized by using status information that is typically gathered for monitoring or used for business purposes unrelated to coordinating process flows within a hierarchical process flow. The hierarchical process flow can include a command within a process flow to wait until an object associated with another process flow has been set to a trigger status value. The hierarchical process flow can be generated without knowing how to generate code for any particular programming language. Also, a flag or other specialized, binary-valued variable does not need to be generated and used. Thus, business people can generate hierarchical process flows, even if those business people have little programming experience or have little time to generate and test newly developed code. The generation and use of the hierarchical process flow can be performed at least in part using a data processing system including a processor readable medium.

A few terms are defined or clarified to aid in understanding the terms as used throughout this specification. The term “child process flow” is intended to mean a process flow that lies at a lower level within the hierarchical process flow in reference to another process flow. For the purposes of this specification, child process flow can include a process flow that is one, two, or more levels lower than the other process flow.

The term “hierarchical process flow” is intended to mean a process flow that includes process flows at different levels. A highest level within the hierarchy can be called a principal process flow. An example of a hierarchical process flow can include a project workflow, a strategy workflow, or the like.

The term “object” is intended to mean a representation of a process flow or a portion thereof, or a representation of an entity (e.g., purchase order, project, phase, strategy, initiative) whose handling the process flow defines.

The term “parent process flow” is intended to mean a process flow that is at a higher level within the hierarchical process flow in reference to another process flow. For the purposes of this specification, parent process flow can include a process flow that is one, two, or more levels higher than the other process flow.

The term “pull,” and its variants, is intended to mean to receive information in response to a request for such information. The term “push,” and its variants, is intended to mean to receive information without requesting such information. As used in this specification, pulling and pushing is not limited to client-server computing relationships.

The term “status value” is intended to mean a value that reflects a status of an object. The status may include a past, current, or future status of the object.

The term “trigger status value” is intended to mean a status value that satisfies a wait condition.

The term “when” is intended to mean occurring simultaneously or after another point in time or period of time.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one, and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware, and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

The methods and systems described herein can be used for hierarchical process flows. With a hierarchical process flow, the at least two different levels of process flows are present. A hierarchical process flow can vary from simple to very complex. Examples of hierarchical process flows can include a project workflow, a strategy workflow, or the like. One or more of the process flows can be semi-independent meaning that a portion of such process flow(s) can be include a part that may be performed without having to wait for another process flow or portion of that other process flow, but can also include another part that may need to wait for the other process flow or a portion of that other process flow.

A project workflow may have a principal level, which may be called a project level. The project workflow can also include an immediate lower level, which may be called the phase level that includes one or more phase process flows. The phase level can correspond to different phases of the project. The phase level can also include an immediate lower level, which may be called the task level that include one or more task process flows. The task level can correspond to different tasks within a phase of the project.

A project can be of nearly any scope, such as a repair request for a computer, installing a software patch on a server, a significant upgrade on a software program, complete replacement of the current network system (replace a set of servers using one operating system to another set of servers using a different operating system), other suitable set of actions, or any combination thereof. Note that projects can be for nearly anything and are not limited to computer, software, and networking environments. For example, a project could be replacing gas pumps at gas stations owned by a company, launching a space shuttle, performing landscaping, making a next generation medical device for neurosurgery, or the like. Thus, a project workflow can be of nearly any size, for nearly any area of endeavor, or any combination thereof.

A strategy workflow may have a principal level, which may be called a strategy level. The strategy workflow can also include an immediate lower level, which may be called an initiative level that includes one or more initiative process flows. The initiative level can correspond to different initiatives of the strategy. The initiative level can also include an immediate lower level, which may be called the program level that include one or more program process flows. The program level can correspond to different programs within an initiative of the strategy. Similar to the project workflow, a strategy workflow can be of nearly any scope. Thus, a strategy workflow can be of nearly any size, for nearly any area of endeavor, or any combination thereof.

In one embodiment, each immediate parent process level can have any number of immediate child process flows; however, each immediate child process flow can have only one immediate parent process flow. In a particular embodiment, immediate child process flows (i.e., sibling process flows) cannot directly interact with each other. However, sibling process flows may be able to indirectly interact with each other via the immediate parent process flow.

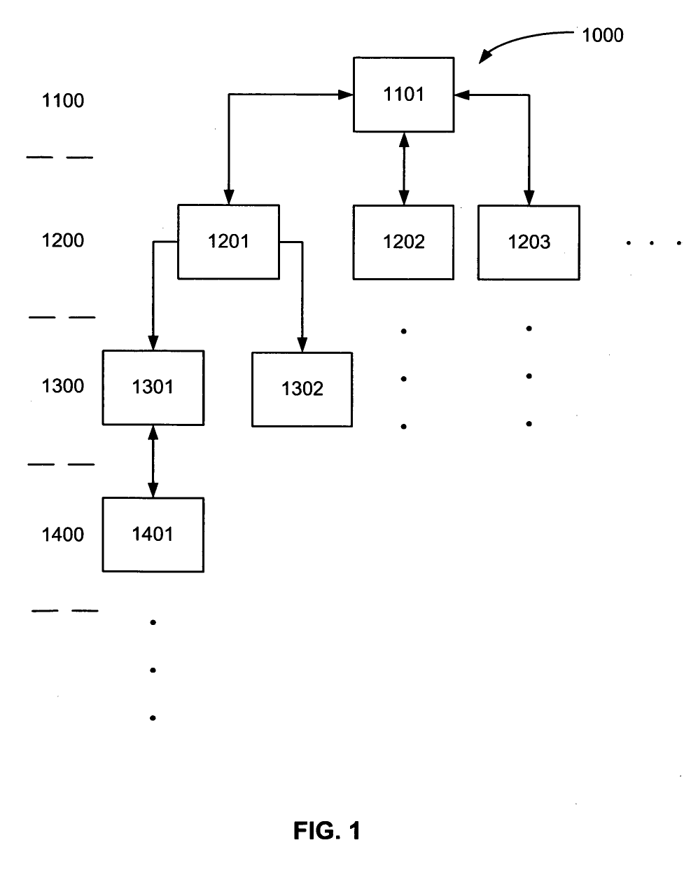

FIG. 1 includes an exemplary, non-limiting embodiment of a hierarchical process flow 1000. Level 1100 corresponds to principal or highest level, level 1200 corresponds to the next highest level, level 1300 corresponds to the next highest level, and level 1400 corresponds to the next highest level. More or fewer levels may be used. Process flow 1101 corresponds to the principal process flow, which lies at the level 1100. The process flow 1101 is the immediate parent for process flows 1201, 1202, and 1203, which are immediate children of process flow 1101. More or fewer process flows may lie at level 1200. The process flow 1201 is the immediate parent for process flows 1301 and 1302, which are immediate children of process flow 1201. The process flows 1202 and 1203 may have child process flows, but are not illustrated in FIG. 1. Each of process flows 1201, 1202, and 1203 may include more or fewer immediate child process flows at level 1300. The process flow 1301 is the immediate parent for process flow 1401, which is an immediate child of process flow 1301. The process flow 1301 may include more or fewer immediate child process flows. As illustrated in FIG. 1, process flow 1302 does not have any child process flows. Process flow 1401 may include more or fewer immediate child process flows at a lower level.

All process flows lying at levels below the process flow 1101 are child process flows with respect to the process flow 1101. The process flows 1201, 1202, and 1203 are immediate child process flows with respect to the process flow 1101; the process flows 1301 and 1302 are grandchild process flows with respect to the process flow 1101 and immediate child process flows with respect to the process flow 1201; and the process flow 1401 is a great grandchild process flow with respect to the process flow 1101, a grandchild process flow with respect to the process flow 1201, and an immediate child process flow with respect to the process flow 1301.

After reading this specification, skilled artisans appreciate that many other hierarchical process flows can be generated. The number of levels, amount of branching, or the like can be varied to achieve nearly any hierarchical process flow desired. While methods and systems are described below with respect to FIG. 1, after reading this specification, skilled artisans will appreciate that the concepts can be applied to many different hierarchical process flows.

Automating hierarchical process flows is desirable but not always at the expense of significant code generation. One or more process flows within the hierarchical process flow 1000 may depend in part on other process flows. A flag or other specialized, binary-state variable (hereinafter “flag”) could be used to help synchronize the process flow. However, the flag would require significant code generation for declaring the flag, placing, and properly using the flag throughout a software program corresponding to the hierarchical process flow. Such significant code generation can limit the ability of individuals to generate hierarchical process flows, particularly those that do not have the proper training or the time to generate and test such coding.

Status information regarding hierarchical process flows is typically kept and recorded for many different reasons, including for example, project tracking, time keeping, budgeting, one or more other business reasons, or any combination thereof. A software program for use with a hierarchical process flow can include nearly any number of status values. An example of status value can include requested, initialized, approved, open, on-hold, completed, cancelled, denied, or the like. Of those status values, on-hold, cancelled, denied may be considered to be inactive, and the rest may be considered active. Customize status values can also be created. After reading this specification, skilled artisans will appreciate that more of fewer status values may be used, that other status values may be used in place of or in addition to the other status values, or any combination thereof.

Process flows within a hierarchical process flow can be synchronized by using one or more status values of objects associated with process flows. Because status values of objects are used, flags do not need to be generated, and therefore, significant code generation is not required when an individual is generating a hierarchical process flow that includes one or more process flows that are to be coordinated with one or more other process flows.

A method of generating a hierarchical process flow and using the hierarchical process flow can be performed in hardware, software, or a combination thereof. In a particular embodiment, a software program can include tools to aid in the generating and using the hierarchical process flow. The software program may include constraints for generating or using the hierarchical process flow. In one embodiment, a parent process flow may only be allowed to wait on one or more of its immediate child processes and no other child processes (e.g., grandchildren, great grandchildren, etc.). In a particular embodiment, a parent process flow may wait for all of its immediate child process flows.

Referring to FIG. 1, the process flow 1201 may wait for the process flows 1301 and 1302. In other embodiment, a child process flow can wait for one or more parent process flows. In a particular embodiment, a child process flow can only wait for an immediate parent process flow, a parent flow at the highest level, or any combination thereof, but no parent process flow between the immediate parent process flow and the parent process flow at the highest level. Referring to FIG. 1, the process flow 1401 may wait for the process flow 1301, 1101, or both, but not wait for the process flow 1201. In still another embodiment, sibling process flows may not directly wait for each other. Referring to FIG. 1, the process flow 1301 may not directly wait for the process flow 1302; however, the process flow 1301 may indirectly wait for the process flow 1302 via the process flow 1201. The indirect waiting for sibling process flows is described in more detail with respect to the Example, near the end of the Detailed Description. More, fewer, or other constraints can be used. After reading this specification, skilled artisans can determine what constraints may be used.

The constraints can be in the form of software, hardware, or a combination thereof. Such software, hardware, or combination thereof can allow a data processing system to be configured to allow or not allow code (e.g., processor-readable instructions) corresponding to one or more process flows within the hierarchical process flow to be generated, executed, or a combination thereof.

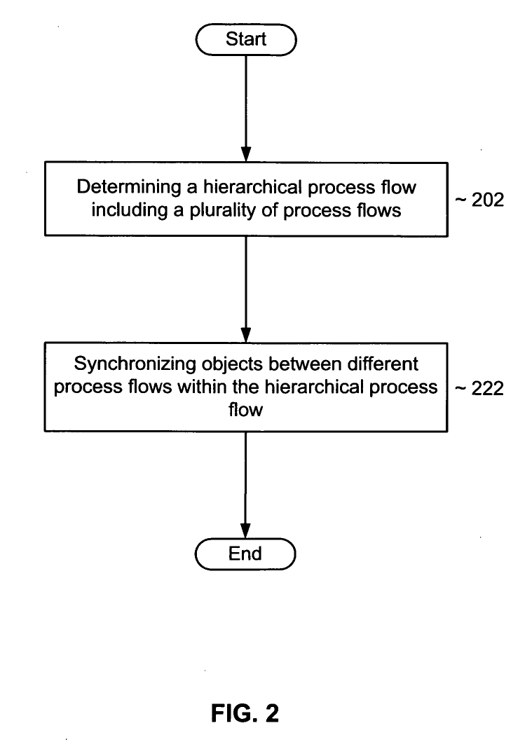

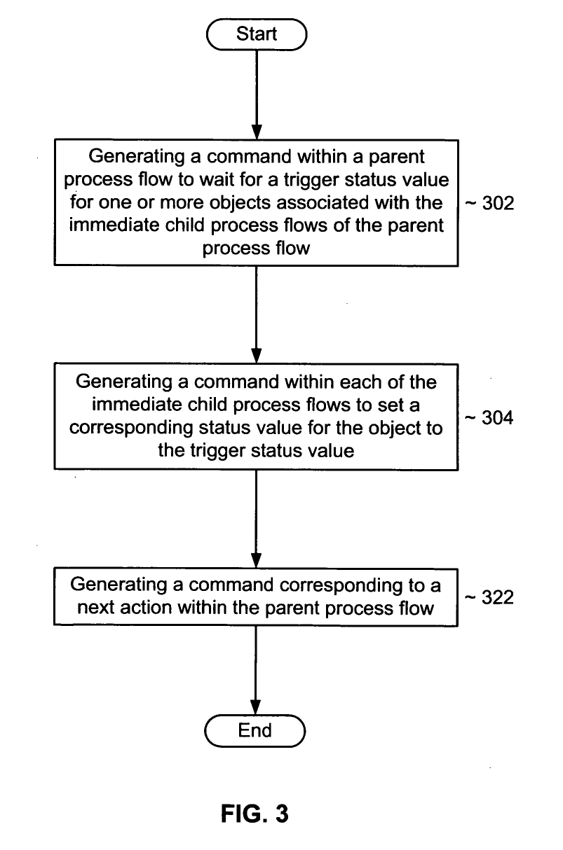

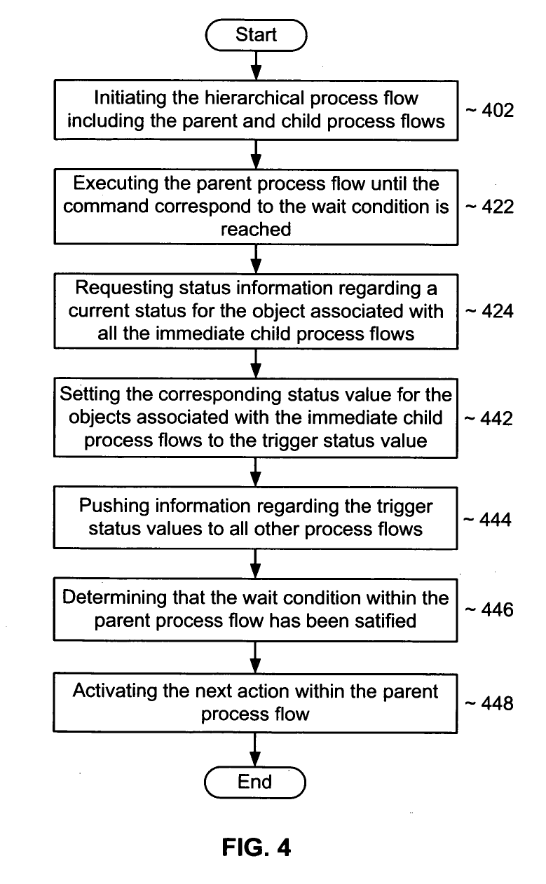

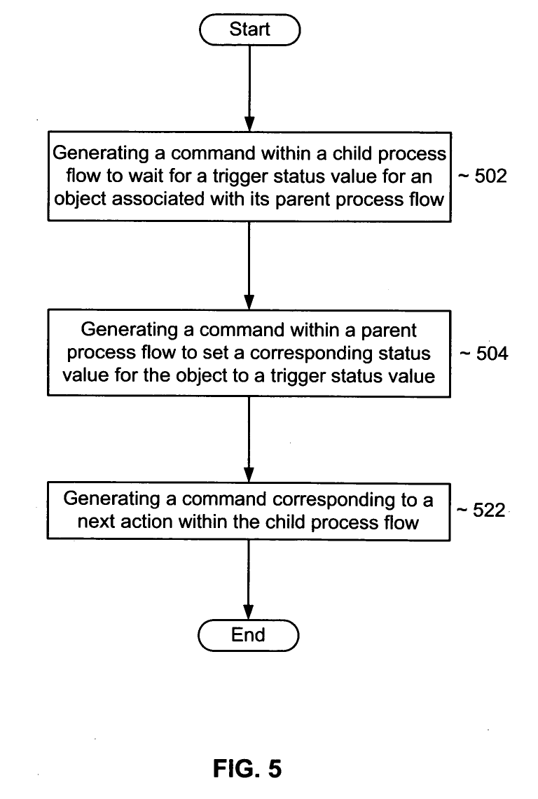

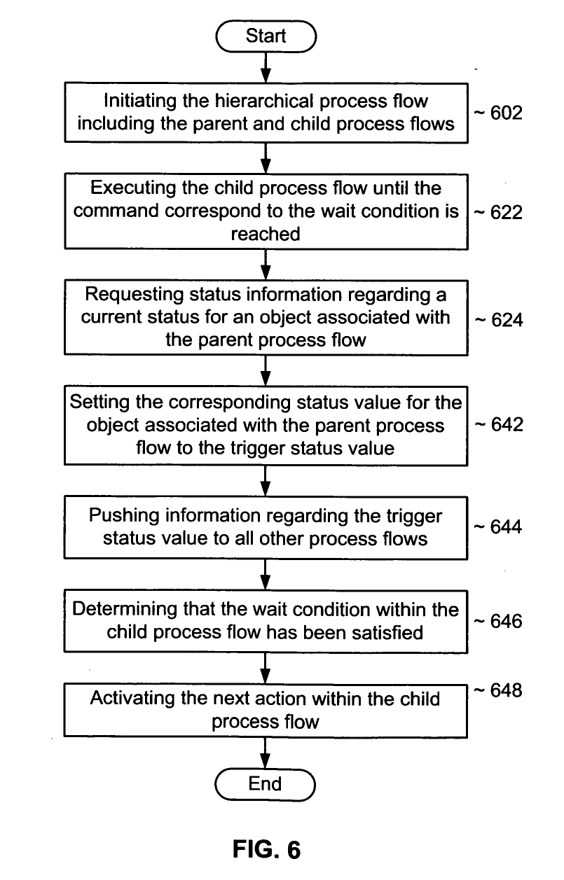

Attention is now directed to specific aspects of generating and using a hierarchical flow. FIG. 2 includes a flowchart for generating a hierarchical process flow that includes synchronization between different process flows within the hierarchical process flow. The method can include determining a hierarchical process flow including a plurality of process flows, at block 202, and synchronizing objects between different process flows within the hierarchical process flow, at block 204. FIG. 1 includes an exemplary process flow that may be the process of the activity in block 202. The activity of synchronizing objects in block 204 will be described with respect to FIG. 1. FIGS. 3 and 4 are related to a parent process flow that is to wait for a child process flow, and FIGS. 5 and 6 are related to a child process flow that is to wait for a parent process flow. After reading this specification, skilled artisans will appreciation that more or fewer actions as given in FIGS. 3 through 6 could be used.

In one embodiment, the hierarchical process flow 1100 in FIG. 1 can correspond to a project, and the process flow 1101 can be the project process flow. The project may include an investigation phase (process flow 1201), a development phase (process flow 1202), a testing phase (process flow 1203), or the like. In one embodiment, the investigation phase is to be completed before the other phases begin. The project may wait until the investigation is complete. In one embodiment, a status value of “investigation-completed” may be created and used.

The method can include generating a command within a parent process flow to wait for a trigger status value for one or more objects associated with the immediate child process flows of the parent process flow, at block 302 in FIG. 3. Referring to FIG. 1, a user can generate a command within the process flow 1101 to wait for a trigger status value for an object associated with the process flow 1201. For example, the object can be the process flow 1201. In one particular embodiment, the project (process flow 1101)is waiting for the investigation phase (process flow 1201) to be completed.

The method can also include generating a command within each of the immediate child process flows to set a corresponding status value for the associated object to the trigger status value, at block 304 in FIG. 3. In a particular embodiment, a constraint can be that all immediate child process flow must have the trigger status value for the object. Referring to FIG. 1, a user can generate a command within each of the process flows 1201, 1202, and 1203 that sets the trigger status value so that the wait condition within the process flow 1101 is satisfied when objects associated with all of the process flows 1201, 1202, and 1203 have the trigger status value. In one particular embodiment, the project (process flow 1101) is waiting for the investigation phase (process flow 1201) to be completed. Objects can be the process flows 1201, 1202, and 1203. When the investigation phase is completed, the trigger status value for an object corresponding to process flow 1201 is set to investigation-completed. Objects associated with the other process flows 1202 and 1203 may be set to the trigger status values of investigation-completed before or at about the same time as the object associated with the process flow 1201 is set to investigation-completed. In this manner, the hierarchical process flow can be designed to have the project (process flow 1101) wait for objects associated with all its immediate child process flows (process flow 1201, 1202, and 1203) until each object has the trigger status value of investigation-completed.

The method can further include generating a command corresponding to a next action within the parent process flow, at block 322 of FIG. 3. After the wait condition is satisfied, the project (process flow 1101) can resume. The next action within process flow 1101 would become active. The next action could correspond to an activity that is to be performed within the process flow 1101 or may activate another phase of the project, such as development phase, which may correspond to process flow 1202.

A data processing system can receive the commands as described with respect to FIG. 3 can convert the commands into instructions to direct the process flows to perform actions as recited in the commands. For example, generating a command within a parent process flow to wait for a trigger status value for an object associated with the immediate child process flows of the parent process flow can be converted by the data processing system to an instruction to direct a parent process flow to wait for a trigger status value for each an object associated with each of the immediate child process flows of the parent process flow.

FIG. 4 includes a flowchart for using a hierarchical process flow that is designed for a parent process flow to wait on a child process flow. The method can include initiating the hierarchical process flow including the parent and child process flows, at block 402. The method can also include executing the parent process flow until the command corresponding to the wait condition is reached, at block 422. The method can still further include requesting status information regarding a current status for the objects associated with all the immediate child process flows, at block 424.

In one embodiment, the project (process flow 1101) may be proceeding and then reach a wait condition corresponding to waiting until the investigation phase is completed. The process flow 1101 may request information regarding its immediate child process flows to see if the wait condition is satisfied. The method can include determining if objects associated the immediate child process flows and corresponding to the wait condition have corresponding status values that are the trigger status value. None, one, some, or all of the immediate child process flows may include objects that already have the trigger status value, which in one particular embodiment is investigation-completed. If the objects associated with all the immediate child process flows have the trigger status value (investigation-completed), the wait condition is satisfied, and the process flow 1101 can continue.

However, one or more objects associated with one, some, or all of the immediate child process flows may have corresponding status values that are not the trigger status value. The process flow 1101 will wait until the corresponding status values are set to the trigger status value. For example, process flow 1201 can correspond to the investigation phase, which may be open but not complete. Thus, the object associated with the process flow 1201 may have a corresponding status value of open.

In another embodiment, immediate child processes that have reached the trigger status value and progressed to another status value may be considered as satisfying their part of the wait condition, just as if they were still at the trigger status value. Status change routines may maintain a history of the status values for each object to support this test. In another embodiment, further conditions on the current status of an object may apply (for example, a sequential ordering of the status values, or a categorization of status values as “active” and “inactive”) to determine whether such an object that reached the trigger status value in the past, and subsequently changed to a different status, satisfies the wait condition.

At a later time, the investigation phase is completed. The method can include setting the corresponding status value for the object associated with the child process flows to the trigger status value, at block 442. In a particular embodiment, the process flow 1201 is completed, and the data processing system can set the corresponding status value of the object associated with the process flow 1201 to investigation-completed, which is the trigger status value. The method can also include pushing information regarding the trigger status value to all other process flows, at block 444. The data processing system can push the changed status value to the other process flows in real time. By pushing data, the need for iterating a request, if pulling were to be used, and the dilemma of how often to request the information can be obviated. Therefore, system resources are not wasted on requests that did not need to be made, and the hierarchical process flow can proceed quicker because the changed status information is provided in real time (e.g., no more than a second delay) without a delay associated with making the next request if a pulling technique is used. Any process flow that is not waiting for the object can receive the changed status information but effectively ignores such changed status information.

The method can further include determining that the wait condition within the parent process flow has been satisfied, at block 446. After receiving the status information, the data processing system can determine that the wait condition within the process (process flow 1101) has been satisfied. The method can still further include activating the next object (e.g., an activity) within the parent process flow, at block 448. The method can yet further continue until the hierarchical process flow is completed.

Attention is now directed to an embodiment in which a child process flow is to wait for a parent process flow. In one embodiment, the hierarchical process flow 1100 in FIG. 1 can correspond to a project workflow, and the process flow 1101 can be the project process flow. The project may include an investigation phase (process flow 1201), a development phase (process flow 1202), a testing phase (process flow 1203), or the like. In a particular embodiment, the investigation phase is not to begin until financial planning and budgets have been generated. Thus, the process flow 1201 can wait on the process flow 1101. In one embodiment, a status value of “investigation” may be created and used.

The method can include generating a command within a child process flow to wait for a trigger status value for an object associated with its parent process flow, at block 502 in FIG. 5. Referring to FIG. 1, a user can generate a command within the process flow 1201 to wait for a trigger status value for an object associated with the process flow 1101. For example, the object can be the process flow 1101. In one particular embodiment, the investigation phase (process flow 1201) is waiting for the status of project (process flow 1101) to be set to investigation.

The method can also include generating a command within a parent process flow to set a corresponding status value for the object to a trigger status value, at block 504 in FIG. 5. Referring to FIG. 1, a user can generate a command within the process flow 1101 that sets the trigger status value so that the wait condition within the process flow 1201 is satisfied when an object associated with the process flow 1101 has the trigger status value. In one particular embodiment, the investigation phase (process flow 1201) is waiting for the status of the project (process flow 1201) to be set to investigation. The object can be the process flow 1101. When the project (process flow 1101) reaches a particular activity, the trigger status value for an object corresponding to process flow 1101 is set to investigation. In this manner, the hierarchical process flow can be designed to have the investigation phase (process flow 1201) wait for an object associated with its immediate parent process flow (process flow 1101) until the object has the trigger status value of investigation.

The method can further include generating a command corresponding to a next action within the child process flow, at block 522 of FIG. 5. After the wait condition is satisfied, the investigation phase (process flow 1201) can begin. The next action within process flow 1201 would become active. The next action could correspond to an activity that is to be performed within the process flow 1201.

A data processing system can receive the commands as described with respect to FIG. 5 can convert the commands into instructions to direct the process flows to perform actions as recited in the commands. For example, generating a command within a child process flow to wait for a trigger status value for an object associated with a parent process flow can be converted by the data processing system to an instruction to direct a child process flow to wait for a trigger status value for an object associated with a parent process flow.

FIG. 6 includes a flowchart for using a hierarchical process flow that is designed for a parent process flow to wait on a child process flow. The method can include initiating the hierarchical process flow including the parent and child process flows, at block 602. The method can also include executing the child process flow until the command corresponding to the wait condition is reached, at block 622. The method can still further include requesting status information regarding a current status for an object associated with the parent process flow, at block 624.

In one embodiment, the project (process flow 1101) and investigation phase (process flow 1201) may be proceeding and then the investigation phase reaches a wait condition corresponding to waiting until the status of the project is investigation. The process flow 1201 may request information regarding its immediate parent process flow to see if the wait condition is satisfied. The method can include determining if an object associated the immediate parent process flow and corresponding to the wait condition has corresponding status value that is the trigger status value. The object corresponding to the parent process flow 1101 may already have the trigger status value, which in one particular embodiment is investigation. If the objects associated with the immediate parent process flow has the trigger status value (investigation), the wait condition is satisfied, and the process flow 1201 can continue.

However, an object associated with the immediate parent process flow may have a corresponding status value that is not the trigger status value. The process flow 1201 will wait until the corresponding status value is set to the trigger status value. For example, a financial planning and budgeting activity may need to be performed for the project before the investigation phase can begin. Thus, the object associated with the process flow 1101 may have a corresponding status value of financial planning or another value other than investigation.

At a later time, the financial planning and budgeting for the project is completed and now the investigation phase of the project can begin. The method can include setting the corresponding status value for the object associated with the parent process flow to the trigger status value, at block 642. In a particular embodiment, the process flow 1101 has a status of investigation, and the data processing system can set the corresponding status value of the object associated with the process flow 1101 to investigation, which is the trigger status value. The method can also include pushing information regarding the trigger status value to all other process flows, at block 644. The data processing system can push the changed status value to the other process flows in real time. Any process flow that is not waiting for the object can receive the changed status information but effectively ignores such changed status information.

The method can further include determining that the wait condition within the child process flow has been satisfied, at block 646. After receiving the status information, the data processing system can determine that the wait condition within the investigation phase (process flow 1201) has been satisfied. The method can still further include activating the next action within the child process flow, at block 648. The method can yet further continue until the hierarchical process flow is completed.

The method and system is flexible and can be used in many other embodiments. For example, although FIGS. 3 through 6 address the investigation phase, wait conditions can be used for a variety of other situations. For example, one or more process flows within the hierarchical process flow may be contingent on a status that may or may not occur. For example, a process flow within the hierarchical process flow may correspond to actions that are to be taken if the project is canceled. Such a process flow may address releasing then-current and future commitments for resources. Alternatively, a different process flow may correspond to when the project is put on-hold. In still another embodiment, the project may correspond to a new product. An object may be associated with a testing phase and include a status of “accelerated testing successful.” One or more other process flows may be waiting for this trigger status value before another activity within a manufacturing or marketing phase is allowed to start. Thus, a process flow for the manufacturing or marketing phase may include a wait condition that is waiting for one or more objects associated with one or more other process flow to be set to a trigger status value of accelerated testing successful.

The concepts described herein can be used for nearly any type of hierarchical process flow, such as a strategy workflow. The length, number of process flows, interrelationships between the process flows, level of complexity, or any combination thereof can be varied as needed or desired.

Many other embodiments can be used. For example, the parent process flow may not need to wait for all of its immediate child process flows. A constraint may be that the parent process flow only needs to wait for one or another number of its immediate child process flows. For example, the project (process flow 1101) may only need to wait until process flow 1201 is completed, but does not need to have corresponding objects embedded within the other immediate child process flows 1202 and 1203. In still another embodiment, a constraint that the parent process flow can wait on any child process flow, and would not be limited only to immediate child process flows. For example, the project (process flow 1101) may directly wait on process flow 1301 to achieve the trigger status value.

In still another embodiment, an object associated with a process flow does not have to be the object corresponding to the process flow. The process flow can include nearly any number of objects that can correspond to activities. In one embodiment, the method can include analyzing one or more objects corresponding to the activities within the process flow. Thus, the object associated with the process flow may be the object corresponding to the process flow or an object corresponding to an activity that is part of the process flow.

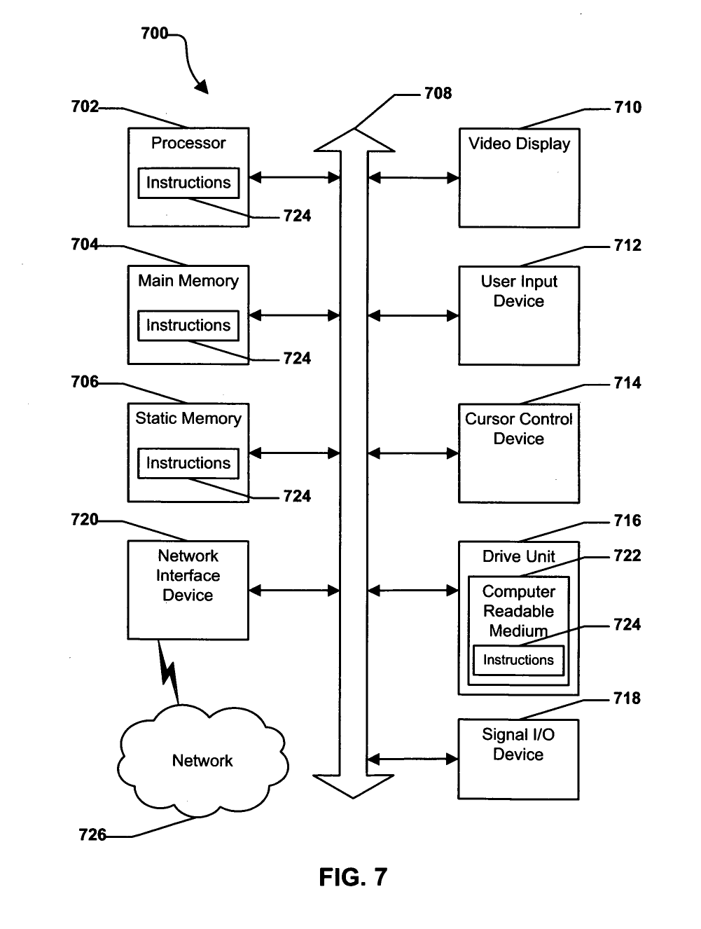

Referring to FIG. 7, an illustrative embodiment of a general data processing system is shown and is designated 700. In one particular embodiment, the data processing system 700 can be a computer system. The data processing system 700 can include a set of instructions that can be executed to cause the data processing system 700 to perform any one or more of the methods or functions disclosed herein. The data processing system 700 may operate as a standalone device or may be connected, e.g., using a network, to one or more other data processing systems or peripheral devices.

In a networked deployment, the data processing system 700 may operate in the capacity of a server or as a client user computer in a server-client user network environment, or as a peer computer system in a peer-to-peer (or distributed) network environment. The data processing system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify one or more actions to be taken by that machine. In a particular embodiment, the data processing system 700 can be implemented using electronic devices that provide voice, video or data communication. Further, while a single data processing system 700 is illustrated, the term “system” shall also be taken to include any individual system or individual sub-system that individually executes, or any collection of one or more systems or one or more sub-system that jointly execute one or more sets of instructions to perform one or more methods or functions.

As illustrated in FIG. 7, the data processing system 700 may include a processor 702, e.g., a central processing unit (CPU), a graphics processing unit (GPU), other suitable processing unit, or any combination thereof. Moreover, the data processing system 700 can include a main memory 704 and a static memory 706, which can communicate with each other via a bus 708. As shown, the data processing system 700 may further include a video display unit 710, such as a liquid crystal display (LCD), an organic light emitting diode (OLED) display, a flat panel display, a solid-state display, or a cathode ray tube (CRT). Additionally, the data processing system 700 may include a user input device 712, such as a keyboard, and a cursor control device 714, such as a mouse, a track ball, a stylus, or the like. The data processing system 700 can also include a disk drive unit 716, a signal input/output (I/O) device 718, such as a microphone, a speaker, remote control, or the like, and a network interface device 720.

In a particular embodiment, as depicted in FIG. 7, the disk drive unit 716 may include a processor-readable medium 722 in which one or more instructions 724, e.g. software, can be embedded. Further, the instructions 724 may embody one or more of the methods, logic, or functions as described herein. In a particular embodiment, the instructions 724 may reside completely, or at least partially, within the main memory 704, the static memory 706, within the processor 702, or any combination thereof during execution by the data processing system 700. The main memory 704 and the processor 702 also may include processor-readable media.

In an alternative embodiment, a dedicated hardware implementation, such as an application specific integrated circuit, programmable logic array, other hardware device, or any combination thereof, can be constructed to implement one or more of the methods described herein. An application that may include an apparatus, a system, or any combination thereof of various embodiments can broadly include a variety of one or more electronic and data processing systems. One or more embodiments described herein may implement one or more functions using two or more specific interconnected hardware modules or devices with related control and data signals that can be communicated between and through the modules, or as portions of an application-specific integrated circuit. Accordingly, the present system can encompass a software implementation, a firmware implementation, a hardware implementation, or any combination thereof.

In accordance with various embodiments of the present disclosure, one or more of the methods described herein may be implemented by a software program executable by a data processing system. Further, in an exemplary, non-limiting embodiment, an implementation can include distributed processing, component/object distributed processing, parallel processing, or any combination thereof. Alternatively, virtual data processing can be constructed to implement one or more of the methods or functionality as described herein.

The present disclosure contemplates a processor-readable medium that includes instructions 724 or receives and executes instructions 724 responsive to a propagated signal, so that a device connected to a network 726 can communicate voice, video or data over the network 726. Further, one or more of the instructions 724 may be transmitted or received over the network 726 via the network interface device 720.

While the processor-readable medium is shown to be a single medium, the term “processor-readable medium” includes a single medium or multiple media, such as a centralized or distributed database, or associated caches and servers that store one or more sets of instructions. The term “processor-readable medium” shall also include any medium that is capable of storing, encoding or carrying a set of instructions for execution by a processor or that cause a data processing system to perform any one or more of the methods or operations disclosed herein.

In a particular non-limiting, exemplary embodiment, the processor-readable medium can include a solid-state memory such as a memory card or other package that houses one or more non-volatile read-only memories. Further, the processor-readable medium can be a random access memory or other volatile re-writable memory. Additionally, the processor-readable medium can include a magneto-optical or optical medium, such as a disk, tape, or other storage device to a capture carrier wave signal, such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a processor-readable medium or a distribution medium and other equivalents and successor media, in which data or instructions may be stored.

Although the present specification may describes one or more components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards can be periodically superseded by faster or more efficient equivalents having substantially the same functions. Accordingly, replacement standards and protocols having substantially the same or similar functions as those disclosed herein are considered equivalents thereof.

In any of the aspects and embodiments described herein, a data processing system can include any one or more data processing system readable media described herein, can be configured to perform any one or more methods described herein, or any combination thereof.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a method of generating a hierarchical process flow can include generating a first command within a first process flow of the hierarchical process flow. The first command includes a wait condition that has a first trigger status value for a first object associated with a second process flow of the hierarchical process flow, and the second process flow is a child of the first process flow. The method can also include generating a second command within the second process flow, wherein when executed, the second command sets a corresponding status value of the first object to the first trigger status value.

In one embodiment of the first aspect, the method can further include generating a third command within a third process flow of the hierarchical process flow. The third process flow is another child of the first process flow. When executed, the third command sets a corresponding status value of a second object associated with the third process flow to the first trigger status value. The wait condition is not satisfied until the first and second objects have the first trigger status value. In another embodiment, the corresponding status object of the first object can have at least three different values, including the first trigger status value.

In still another embodiment of the first aspect, the method can further include pushing information regarding the first trigger status value for the first object to all other process flows within the hierarchical process flow. In a further embodiment, the method can further include generating a third command within the first process flow of the hierarchical process flow, wherein when executed, the third command sets a corresponding status value of a second object associated with the first process flow to a second trigger status value. The method can still further include generating a fourth command within a third process flow of the hierarchical process flow. The third process flow is another child of the first process flow, and the fourth command includes a second wait condition that has the second trigger status value for the second object. In still a further embodiment, a system can be configured to perform part or all of the methods described herein.

In a second aspect, a processor-readable medium can have code to manipulate a processor, wherein the code can include an instruction to generate a first command within a first process flow of the hierarchical process flow. The first command includes a wait condition that has a first trigger status value for a first object associated with a second process flow of the hierarchical process flow. The second process flow is a child of the first process flow. The code can also include an instruction to generate a second command within the second process flow, wherein when executed, the second command sets a corresponding status value of the first object to the first trigger status value.

In one embodiment of the second aspect, the code can further include an instruction to generate a third command within a third process flow of the hierarchical process flow. The third process flow is another child of the first process flow. When executed, the third command sets a corresponding status value of a second object associated with the third process flow to the first trigger status value. The wait condition is not satisfied until the first and second objects have the first trigger status value. In another embodiment, the corresponding status object of the first object can have at least three different values, including the first trigger status value.

In still another embodiment of the second aspect, the code can further include an instruction to push information regarding the first trigger status value for the first object to all other process flows within the hierarchical process flow. In a further embodiment, the code can further include an instruction to generate a third command within the first process flow of the hierarchical process flow, wherein when executed, the third command sets a corresponding status value of a second object associated with the first process flow to a second trigger status value. The code can also include an instruction to generate a fourth command within a third process flow of the hierarchical process flow. The third process flow is another child of the first process flow, and the fourth command includes a second wait condition that has the second trigger status value for the second object. In still a further embodiment, the instruction to generate the first command, the instruction to generate the second command, or any combination thereof is performed in response to user input. In yet a further embodiment, a system can include any of the processor-readable media described herein.

In a third aspect, a processor-readable medium can have code to manipulate a processor, wherein the code can includes an instruction to direct a first process flow within a hierarchical process flow to wait for a first trigger status value for a first object associated with a second process flow within the hierarchical process flow. The second process flow is at a level immediately lower than a level of the first process flow, and the first process flow is configured not to wait for any status value for any object associated with a third process flow within the hierarchical process flow, wherein the third process flow is at least two levels lower than the first process flow within the hierarchical process flow.

In one embodiment of the third aspect, the code can further include an instruction to direct the third process flow to wait for a second trigger status value for a second object associated with the first process flow, wherein the instruction to direct the third process flow to wait is configured to be executed when the first trigger status value for the first object has been set. In another embodiment, the code can further include an instruction to direct a fourth process flow within the hierarchical process flow to wait for a second trigger status value for a second object associated with the first process flow. The second process flow and the fourth process flow lie at a same level with the hierarchical process flow, and the instruction to direct the fourth process flow to wait is configured to be executed when the first trigger status value for the first object has been set.

In still another embodiment, the code can further include an instruction to direct the third process flow within the hierarchical process flow to wait for a second trigger status value for a second object associated with only an immediately higher process flow relative to the third process flow or a highest process flow within the hierarchical process flow, wherein the third process flow is at least two levels lower than the highest process flow. In a further embodiment, the hierarchical process flow includes at least four different levels of process flows, wherein the at least four different levels include the first process flow at a highest level, the second process flow at a next lower level as compared to the first process flow the third process flow at a next lower level as compared to the second process flow, and a fourth process flow within the hierarchical process flow at a next lower level as compared to the third process flow. The code can further include an instruction to direct the fourth process flow is configured to wait for a second trigger status value for a second object associated with the first process flow, the third process flow, or any combination thereof, but is configured not to wait on any status value for any object associated with the second process flow. In still a further embodiment, a system can include any of the processor-readable media described herein.

In a fourth aspect, a processor-readable medium can have code to manipulate a processor, wherein the code can include an instruction to push information regarding the first changed status value for a first object associated with a first process flow within a hierarchical process flow to least one other process flow within a hierarchical process flow, wherein the instruction to push information is configured to be executed when a first prior status value for the first object is set to the first changed status value.

In one embodiment, the code can further include an instruction to direct a second process flow within the hierarchical process flow to wait until receiving the first changed status value for the first object, and an instruction to activate a next action within the second process flow immediately following the command to wait with the second process flow, wherein the instruction to activate is performed in response to receiving information regarding the first changed status value. In a particular embodiment, the code can further include an instruction to request status information regarding a current status value for a second object associated with a second process flow within the hierarchical process flow, wherein the instruction to request status information is executed configured to be on behalf of the first process flow. In a further embodiment, a system can include any of the processor-readable media described herein.

The methods and systems as described herein can be used to generate and use a hierarchical process flow without having to use significant code development resources. Thus, business people do not have to generate, use, and track flags. Process flows within a hierarchical process flow can be generated using status information, which may be used for unrelated business purposes anyway. Also, status values as used in the hierarchical process flow can have nearly any number of different values to meet the needs or desires of the business using the hierarchical process flow, and thus are not limited to only two values as it might be if a flag were to be used. Thus, generation of hierarchical process flows are more intuitive, and less training may be needed regarding generation of hierarchal process flows.

### EXAMPLE

The flexibility of the method and system can be further understood in the non-limiting example described herein. The embodiment as further described in the following example is meant to illustrate potential uses and implementations and does not limit the scope of the invention.

The Example demonstrates that a hierarchical process flow can be generated and used in which one or more of the process flow can be synchronized with one or more other process flows using status values of objects.

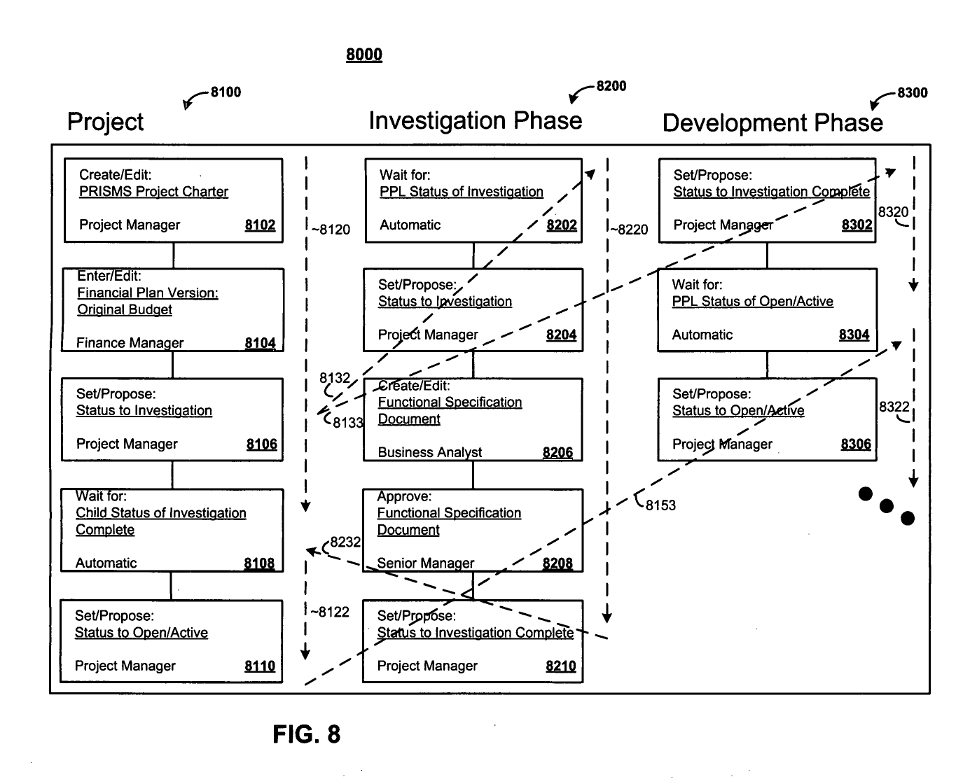

FIG. 8 includes an illustration of a hierarchical process flow 8000 that corresponds to a project workflow. In the project, financial planning and budgeting is to be performed before beginning an investigation phase. The investigation phase is to be completed before work on the development phase is to begin. A project process flow 8100 lies at a highest level within the hierarchical process flow 8000. An investigation process flow 8200 and a development process flow 8300 correspond to the investigation phase and the development phase, respectively. The project process flow 8100 is the immediate parent of the investigation process flow 8200 and development process flow 8300, and the investigation process flow 8200 and development process flow 8300 are the immediate child flows for the project process flow 8100. Other child process flows could be present. For the purposes of illustrating the methods and systems described herein, the process flows 8200 and 8300 will be considered as the only immediate child process flow of project flow 8100.

Commands can be generated corresponding to the actions as illustrated in blocks 8102, 8104, 8106, 8108, and 8110. Each action can include a type of action and a description of the action (e.g., create/edit PRISMS™ brand project charter, enter/edit financial plan version: original budget, set/propose status to investigation, wait for child status of investigation complete, approve functional specification document, etc.) and responsibility for the action (e.g., project manager, finance manager, business analyst, senior manager, automatic, etc.). “Automatic” is used to designate that an activity will be performed by a data processing system without any human intervention.

In the project process flow 8100, a project charter will be created, edited, or both with the project manager being responsible for the project charter (block 8102). A financial manager will be responsible for entering, editing, or both the original budget for the financial plan (block 8104). The project manager will be responsible to set the status of the project process flow 8100 to investigation (block 8106). The project waits until the investigation phase is complete. In block 8108, the project process flow 8100 is waiting for all of the child process flows to have the status of investigation-complete. The action in block 8108 will be performed automatically.

Turning to the investigation process flow 8200, commands can be generated corresponding to the actions as illustrated in blocks 8202, 8204, 8206, 8208, and 8210. The investigation phase waits until the project process flow 8100 (also called principal process flow or PPL) has a status of investigation (block 8202). Block 8202 is an example of a child process flow 8200 waiting for a parent process flow 8100. The action in block 8202 will be performed automatically. The project manager will be responsible to set the status of the investigation phase (process flow 8200) to investigation (block 8204). A business analyst will be responsible for creating, editing, or both the function specification document (block 8206). A senior manager will be responsible for approving the function specification document (block 8208). The project manager will be responsible determining that the investigation phase is complete. The status of the process flow 8200 will be set to investigation-complete.

Returning to the project process flow 8100, the wait condition in block 8108 corresponds to the parent process flow waiting for all child process flows, which includes process flow 8300, which corresponds to the development phase. Commands can be generated corresponding to the actions as illustrated in blocks 8302, 8304, 8306, and potential other blocks (not illustrated in FIG. 8). In order to satisfy the wait condition in block 8108, the development phase (process flow 8300) includes a command to set an object associated with the process flow 8300 to a status value of investigation-complete (block 8302). The action in block 8302 is performed automatically. After the wait condition in block 8108 of the project process flow 8100 is satisfied, the program manager is responsible setting the status of the project process flow 8100 to open/active.

Turning to the development phase in process flow 8300, the development phase waits until the project process flow 8100 has a status of open/active (block 8304). Block 8304 is another example of a child process flow 8300 waiting for a parent process flow 8100. The action in block 8304 will be performed automatically. For the next action in the process flow 8300, the project manager will be responsible for setting the status of the development phase (process flow 8300) to open/active (block 8306).

The project (process flow 8100) and development phase (process flow 8300) include other activities, but such other activities are not illustrated to simplify understanding the generation of the hierarchical process flow. After commands for all of the process flows within the hierarchical process flow 8000 are generated, the hierarchical process flow can be used.

The hierarchical process flow 8000 can be in the form of code that includes instructions to direct a client computer, server, or other data processing system to perform actions corresponding to the commands generated. When the hierarchical process flow 8000 is used, objects associated with the process flows 8100, 8200, and 8300 can be generated automatically. In one embodiment, each of the objects can correspond to the process flows 8100, 8200, 8300 and have corresponding status values. In one non-limiting embodiment, the corresponding status values for the objects can initially be set to a null or other value. When the hierarchical process flow 8000 is started, one or more of the process flows therein can be started.

Referring to the project process flow 8100, the actions corresponding to blocks 8102, 8104, 8106, and 8108 can be executed and performed serially, as illustrated by dashed line 8120. Actions as recited in blocks 8102, 8104, and 8106 can be performed, and information regarding those blocks can be stored or used for one or more different business reasons, such as tracking progress, allowing time to be recorded, resources to be allocated, or the like. After action in block 8106 is performed, an object associated with the project process flow 8100 has its corresponding status value set to investigation. The information regarding the changed status is pushed to the other process flows, which is illustrated by dashed lines 8132 (to the process flow 8200) and 8133 (to the process flow 8300).

The project process flow 8100 continues to block 8108, where the project process flow 8100 waits for objects associated with all the immediate child process flows (process flows 8200 and 8300) to have corresponding status values of investigation-complete.

In one particular embodiment, process flows 8200 and 8300 can be started at substantially the same time as the project process flow 8100. Turning to the process flow 8200, its first action includes waiting for an object associated with the project process flow 8100 to have a corresponding status value of investigation, which is the trigger status value. Initially, the process flow 8200 may request status information and determine that an object associated with the project process flow 8100 is not set to the trigger status value of investigation. For example, the project process flow may be at a status corresponding to block 8102 or 8104. Thus, the investigation phase (process flow 8200) is waiting. After the action corresponding to the block 8106 in the project process flow 8100 is performed, the changed status information is pushed to the other process flows, including process flow 8200. At this point in time, the wait condition corresponding to the block 8202 is satisfied, and thus the process flow 8200 proceeds to block 8204. The actions corresponding to blocks 8204, 8206, 8208, and 8210 are performed serially without any further wait conditions, as illustrated by dashed line 8220. At the end of the process flow 8200, an object associated with process flow 8200 has its corresponding status value set to investigation-complete. The changed status information is pushed to all other flows.

Turning to the development phase (process flow 8300), status information from block 8106 of process flow 8100 is received by the process flow 8300; however such information is effectively ignored because process flow 8300 is not waiting for a status of investigation for the project process flow 8100. The first action (block 8302) within process flow 8300 includes having an object associated with the process flow 8300 set to have a corresponding status value of investigation-complete. Such information regarding the changed status is pushed to all other process flows, including the project process flow 8100. The process flow 8300 that is not waiting for the object, but the process flow receives the changed status information but effectively ignores such changed status information. The next action (block 8304) within the process flow 8300 is to wait for an object associated with the project process flow 8100 to have a corresponding status value of open/active. After the object associated with the project process flow 8100 has a corresponding status value of open/active, the wait condition for block 8304 is met, and then the action corresponding to block 8306 can be performed.

From a practical standpoint, when all process flows within the hierarchical process flow 8000 are initiated, the process project flow 8100 starts with 8102, the investigation process flow 8200 waits for the status of the project process flow 8100 to be at a status of investigate, and the development process flow 8300 can have the status changed relatively quickly and proceed to wait for the project process flow 8100 to be at a status of open/active. Work for the development phase is actually waiting for the investigation phase to be completed, but the investigation phase cannot start until the original budget is determined. After the original budget is complete, the status of the project process flow is changed to allow work on the investigation phase to begin. After the investigation phase is completed, work on the development phase can begin. Thus, one sibling process flow 8300 is waiting on another sibling process flow 8200, albeit indirectly through the parent project process flow 8100. Such a design can be useful if a sibling process flow is not allowed to wait on another sibling process flow.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a method of generating a hierarchical process flow can include generating a first command within a first process flow of the hierarchical process flow. The first command can include a wait condition that has a first trigger status value for a first object associated with a second process flow of the hierarchical process flow, and the second process flow can be a child of the first process flow. The method can also include generating a second command within the second process flow, wherein when executed, the second command sets a corresponding status value of the first object to the first trigger status value.

In one embodiment of the first aspect, the method further includes generating a third command within a third process flow of the hierarchical process flow, wherein the third process flow is another child of the first process flow. When executed, the third command sets a corresponding status value of a second object associated with the third process flow to the first trigger status value. The wait condition is not satisfied until the first and second objects have the first trigger status value. In another embodiment, the corresponding status object of the first object can have at least three different values, including the first trigger status value. In still another embodiment, the method further includes pushing information regarding the first trigger status value for the first object to all other process flows within the hierarchical process flow.

In yet another embodiment of the first aspect, the method further includes generating a third command within the first process flow of the hierarchical process flow, wherein when executed, the third command sets a corresponding status value of a second object associated with the first process flow to a second trigger status value. The method can also further include generating a fourth command within a third process flow of the hierarchical process flow, wherein the third process flow is another child of the first process flow; and the fourth command includes a second wait condition that has the second trigger status value for the second object.

In a second aspect, a processor readable medium can have code to manipulate a processor, wherein the code includes an instruction to generate a first command within a first process flow of the hierarchical process flow, wherein the first command includes a wait condition that has a first trigger status value for a first object associated with a second process flow of the hierarchical process flow; and the second process flow is a child of the first process flow. The code can also include an instruction to generate a second command within the second process flow, wherein when executed, the second command sets a corresponding status value of the first object to the first trigger status value.

In one embodiment of the second aspect, the code further includes an instruction to generate a third command within a third process flow of the hierarchical process flow, wherein the third process flow is another child of the first process flow. When executed, the third command sets a corresponding status value of a second object associated with the third process flow to the first trigger status value, and the wait condition is not satisfied until the first and second objects have the first trigger status value. In another embodiment, the corresponding status object of the first object can have at least three different values, including the first trigger status value.

In still another embodiment of the second aspect, the code further includes an instruction to push information regarding the first trigger status value for the first object to all other process flows within the hierarchical process flow. In a further embodiment, the code further includes an instruction to generate a third command within the first process flow of the hierarchical process flow, wherein when executed, the third command sets a corresponding status value of a second object associated with the first process flow to a second trigger status value. The code also further includes an instruction to generate a fourth command within a third process flow of the hierarchical process flow, wherein the third process flow is another child of the first process flow, and the fourth command includes a second wait condition that has the second trigger status value for the second object. In still a further embodiment, the instruction to generate the first command, the instruction to generate the second command, or any combination thereof is performed in response to user input.

In a third aspect, a processor readable medium can have code to manipulate a processor, wherein the code includes an instruction to direct a first process flow within a hierarchical process flow to wait for a first trigger status value for a first object associated with a second process flow within the hierarchical process flow. The second process flow can be at a level immediately lower than a level of the first process flow; and the first process flow can be configured not to wait for any status value for any object associated with a third process flow within the hierarchical process flow, wherein the third process flow is at least two levels lower than the first process flow within the hierarchical process flow.

In one embodiment of the third aspect, the code further includes an instruction to direct the third process flow to wait for a second trigger status value for a second object associated with the first process flow, wherein the instruction to direct the third process flow to wait is configured to be executed when the first trigger status value for the first object has been set. In another embodiment, the code further includes an instruction to direct a fourth process flow within the hierarchical process flow to wait for a second trigger status value for a second object associated with the first process flow, wherein the second process flow and the fourth process flow lie at a same level with the hierarchical process flow. The instruction to direct the fourth process flow to wait is configured to be executed when the first trigger status value for the first object has been set.

In still another embodiment of the third aspect, the code further includes an instruction to direct the third process flow within the hierarchical process flow to wait for a second trigger status value for a second object associated with only an immediately higher process flow relative to the third process flow or a highest process flow within the hierarchical process flow, wherein the third process flow is at least two levels lower than the highest process flow. In yet another embodiment, the hierarchical process flow includes at least four different levels of process flows, the four different levels can include the first process flow at a highest level, the second process flow at a next lower level as compared to the first process flow, the third process flow at a next lower level as compared to the second process flow, a fourth process flow within the hierarchical process flow at a next lower level as compared to the third process flow. The code further includes an instruction to direct the fourth process flow is configured to wait for a second trigger status value for a second object associated with the first process flow, the third process flow, or any combination thereof, but is configured not to wait on any status value for any object associated with the second process flow.

In a fourth aspect, a processor readable medium can have code to manipulate a processor, wherein the code includes an instruction to push information regarding the first changed status value for a first object associated with a first process flow within a hierarchical process flow to least one other process flow within a hierarchical process flow, wherein the instruction to push information is configured to be executed when a first prior status value for the first object is set to the first changed status value.

In one embodiment of the fourth aspect, the code further includes an instruction to direct a second process flow within the hierarchical process flow to wait until receiving the first changed status value for the first object, and an instruction to activate a next action within the second process flow immediately following the command to wait with the second process flow, wherein the instruction to activate is performed in response to receiving information regarding the first changed status value. In a particular embodiment, the code further includes an instruction to request status information regarding a current status value for a second object associated with a second process flow within the hierarchical process flow, wherein the instruction to request status information is executed configured to be on behalf of the first process flow.

In any of the aspects and embodiments described herein, a system, such as a data processing system, can include any one or more processor readable media described herein, can be configured to perform any one or more methods described herein, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that a structural substitution, logical substitution, or another change may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed subject matter require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of generating a hierarchical process flow comprising:
generating a first command within a first process flow of the hierarchical process flow, wherein:
the first command includes a wait condition that has a first trigger status value for a first object associated with a second process flow of the hierarchical process flow; and
the second process flow is a child of the first process flow; and
generating a second command within the second process flow, wherein when executed, the second command sets a corresponding status value of the first object to the first trigger status value.

2. The method of claim 1, further comprising generating a third command within a third process flow of the hierarchical process flow, wherein:
the third process flow is another child of the first process flow;
when executed, the third command sets a corresponding status value of a second object associated with the third process flow to the first trigger status value; and
the wait condition is not satisfied until the first and second objects have the first trigger status value.

3. The method of claim 1, wherein the corresponding status object of the first object can have at least three different values, including the first trigger status value.

4. The method of claim 1, further comprising pushing information regarding the first trigger status value for the first object to all other process flows within the hierarchical process flow.

5. The method of claim 1, further comprising:
generating a third command within the first process flow of the hierarchical process flow, wherein when executed, the third command sets a corresponding status value of a second object associated with the first process flow to a second trigger status value; and
generating a fourth command within a third process flow of the hierarchical process flow, wherein:
the third process flow is another child of the first process flow; and
the fourth command includes a second wait condition that has the second trigger status value for the second object.

6. A system configured to perform the method of claim 1.

7. A processor readable medium having code to manipulate a processor, wherein the code comprises:
an instruction to generate a first command within a first process flow of the hierarchical process flow, wherein:
the first command includes a wait condition that has a first trigger status value for a first object associated with a second process flow of the hierarchical process flow; and
the second process flow is a child of the first process flow; and
an instruction to generate a second command within the second process flow, wherein when executed, the second command sets a corresponding status value of the first object to the first trigger status value.

8. The processor readable medium of claim 7, wherein the code further comprises an instruction to generate a third command within a third process flow of the hierarchical process flow, wherein:
the third process flow is another child of the first process flow;
when executed, the third command sets a corresponding status value of a second object associated with the third process flow to the first trigger status value; and
the wait condition is not satisfied until the first and second objects have the first trigger status value.

9. The processor readable medium of claim 7, wherein the corresponding status object of the first object can have at least three different values, including the first trigger status value.

10. The processor readable medium of claim 7, wherein the code further comprises an instruction to push information regarding the first trigger status value for the first object to all other process flows within the hierarchical process flow.

11. The processor readable medium of claim 7, wherein the code further comprises:
an instruction to generate a third command within the first process flow of the hierarchical process flow, wherein when executed, the third command sets a corresponding status value of a second object associated with the first process flow to a second trigger status value; and
an instruction to generate a fourth command within a third process flow of the hierarchical process flow, wherein:
the third process flow is another child of the first process flow; and
the fourth command includes a second wait condition that has the second trigger status value for the second object.

12. The processor readable medium of claim 7, wherein the instruction to generate the first command, the instruction to generate the second command, or any combination thereof is performed in response to user input.

13. A system comprising the processor readable medium of claim 7.

14. A processor readable medium having code to manipulate a processor, wherein the code comprises:
an instruction to direct a first process flow within a hierarchical process flow to wait for a first trigger status value for a first object associated with a second process flow within the hierarchical process flow, wherein:
the second process flow is at a level immediately lower than a level of the first process flow; and
the first process flow is configured not to wait for any status value for any object associated with a third process flow within the hierarchical process flow, wherein the third process flow is at least two levels lower than the first process flow within the hierarchical process flow.

15. The processor readable medium of claim 14, wherein the code further comprises:
an instruction to direct the third process flow to wait for a second trigger status value for a second object associated with the first process flow, wherein the instruction to direct the third process flow to wait is configured to be executed when the first trigger status value for the first object has been set.

16. The processor readable medium of claim 14, wherein the code further comprises:
an instruction to direct a fourth process flow within the hierarchical process flow to wait for a second trigger status value for a second object associated with the first process flow, wherein:
the second process flow and the fourth process flow lie at a same level with the hierarchical process flow; and
the instruction to direct the fourth process flow to wait is configured to be executed when the first trigger status value for the first object has been set.

17. The processor readable medium of claim 14, the code further comprises an instruction to direct the third process flow within the hierarchical process flow to wait for a second trigger status value for a second object associated with only an immediately higher process flow relative to the third process flow or a highest process flow within the hierarchical process flow, wherein the third process flow is at least two levels lower than the highest process flow.

18. The processor readable medium of claim 14, wherein:
the hierarchical process flow comprises at least four different levels of process flows, wherein the at least four different levels include:
the first process flow at a highest level;
the second process flow at a next lower level as compared to the first process flow;
the third process flow at a next lower level as compared to the second process flow; and
a fourth process flow within the hierarchical process flow at a next lower level as compared to the third process flow;
the code further comprises an instruction to direct the fourth process flow is configured to wait for a second trigger status value for a second object associated with the first process flow, the third process flow, or any combination thereof, but is configured not to wait on any status value for any object associated with the second process flow.

19. A system comprising the processor readable medium of claim 14.

20. A processor readable medium having code to manipulate a processor, wherein the code comprises:
an instruction to push information regarding the first changed status value for a first object associated with a first process flow within a hierarchical process flow to least one other process flow within a hierarchical process flow, wherein the instruction to push information is configured to be executed when a first prior status value for the first object is set to the first changed status value.

21. The processor readable medium of claim 20, wherein the code further comprises:
an instruction to direct a second process flow within the hierarchical process flow to wait until receiving the first changed status value for the first object;
an instruction to activate a next action within the second process flow immediately following the command to wait with the second process flow, wherein the instruction to activate is performed in response to receiving information regarding the first changed status value.

22. The processor readable medium of claim 21, wherein the code further comprises:
an instruction to request status information regarding a current status value for a second object associated with a second process flow within the hierarchical process flow, wherein the instruction to request status information is executed configured to be on behalf of the first process flow.

23. A system comprising the processor readable medium of claim 20.
